(19) United States
(12) Patent Application Publication
(10) Pub. No.: US 2022/0398616 A1
(43) Pub. Date: Dec. 15, 2022

(54) INFORMATION PROCESSING DEVICE, INFORMATION PROCESSING METHOD, AND NON-TRANSITORY COMPUTER-READABLE MEDIUM

(71) Applicant: TOYOTA JIDOSHA KABUSHIKI KAISHA, Toyota-shi (JP)

(72) Inventors: Naoya OKA, Nagakute-shi (JP); Satoshi KITAMURA, Nagoya-shi (JP); Yusuke SOBUE, Nagoya-shi (JP); Seira NAKADA, Nagoya-shi (JP); Mami MORI, Nagoya-shi (JP); Masato MORISHIMA, Nagoya-shi (JP); Yasuyuki NUNOKAWA, Nagoya-shi (JP)

(73) Assignee: TOYOTA JIDOSHA KABUSHIKI KAISHA, Toyota-shi (JP)

(21) Appl. No.: 17/749,582

(22) Filed: May 20, 2022

(30) Foreign Application Priority Data
Jun. 10, 2021 (JP) 2021-097545

(51) Int. Cl. G06Q 30/02; G06Q 30/06

(52) U.S. Cl. CPC G06Q 30/0207; G06Q 30/0645

(57) ABSTRACT

A processor of a server acquires information related to a person involved in a long-term use agreement on a vehicle when information indicating a request to use a rental car is acquired from a terminal of a user. When determination is made that the user is the person involved in the long-term use agreement on the vehicle, the processor outputs a discounted fee obtained by reducing a fee for the use of the rental car.

### CROSS-REFERENCE TO RELATED APPLICATION

This application claims priority to Japanese Patent Application No. 2021-097545 filed on Jun. 10, 2021, incorporated herein by reference in its entirety.

### BACKGROUND

### 1. Technical Field

The present disclosure relates to an information processing device, an information processing method, and a non-transitory computer-readable medium.

### 2. Description of Related Art

Hitherto, there is known a technology for setting a rental fee when a battery electric vehicle using, as a drive source, an electric motor to be driven by a battery is rented as a rental car or a leased vehicle (for example, Japanese Unexamined Patent Application Publication No. 2013-084199 (JP 2013-084199 A)).

### SUMMARY

It is an object of the present disclosure to provide an information processing device, an information processing method, and a program that can improve convenience of a person involved in a long-term use agreement on a vehicle.

An aspect of the present disclosure relates to an information processing device. The information processing device includes a processor. The processor is configured to: when first information is acquired from a user, acquire second information, the first information indicating a request for a first use of a first vehicle for a first period, the second information being related to a user involved in an agreement on a second vehicle different from the first vehicle, the user involved in the agreement having concluded an agreement on a second use of the second vehicle for a second period, the second period being longer than the first period; determine whether the user is the user involved in the agreement on the second vehicle based on the first information and the second information; and output a discounted fee obtained by reducing a fee for the first use when determination is made that the user is the user involved in the agreement on the second vehicle.

Another aspect of the present disclosure relates to an information processing method. The information processing method includes: when a processor has acquired first information from a user, acquiring second information by the processor; determining, by the processor, whether the user is the user involved in the agreement on the second vehicle based on the first information and the second information; and outputting, by the processor, a discounted fee obtained by reducing a fee for the first use when determination is made that the user is the user involved in the agreement on the second vehicle. The first information indicates a request for a first use of a first vehicle for a first period. The second information is related to a user involved in an agreement on a second vehicle different from the first vehicle. The user involved in the agreement has concluded an agreement on a second use of the second vehicle for a second period. The second period is longer than the first period.

Another aspect of the present disclosure relates to a non-transitory computer-readable medium on which a program is recorded. When the program is executed by a processor, the program causes an information processing device to: when first information is acquired from a user, acquire second information, the first information indicating a request for a first use of a first vehicle for a first period, the second information being related to a user involved in an agreement on a second vehicle different from the first vehicle, the user involved in the agreement having concluded an agreement on a second use of the second vehicle for a second period, the second period being longer than the first period;

determine whether the user is the user involved in the agreement on the second vehicle based on the first information and the second information; and output a discounted fee obtained by reducing a fee for the first use when determination is made that the user is the user involved in the agreement on the second vehicle.

According to the present disclosure, it is possible to improve the convenience of the person involved in the long-term use agreement on the vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram of an information processing system according to an embodiment;

FIG. 2 is a diagram showing a configuration example of a terminal device that can be used as a terminal or a server;

FIG. 3 is a diagram showing an example of a data structure of a management table;

FIG. 4 is a diagram showing an example of a data structure of a vehicle database;

FIG. 5 is a flowchart showing an example of a process in the server; and

FIG. 6 is a flowchart showing an example of a process in the server.

### DETAILED DESCRIPTION OF EMBODIMENTS

An information processing device according to an embodiment includes a control unit. The control unit performs the following.

(1) When first information indicating a request for a short-term use of a first vehicle is acquired from a user, the control unit acquires second information related to a person involved in a long-term use agreement on a second vehicle different from the first vehicle.
(2) When determination is made from the first information and the second information that the user is the person involved in the long-term use agreement on the second vehicle, the control unit outputs a discounted fee obtained by reducing a fee for the short-term use of the first vehicle.

According to the information processing device, the control unit outputs the discounted fee for the short-term use of the first vehicle when the user is the person involved in the long-term use agreement on the second vehicle. Therefore, the user who is the person involved in the long-term use agreement can use the first vehicle for the short period at a lower cost than that for a person who is not involved in the agreement. This makes it possible to improve the convenience of the user who is the person involved in the long-term use agreement.

The first vehicle refers to a vehicle for the short-term use. The “short-term use” refers to a use for a period of, for example, several hours, several days, or one week, and includes, for example, car rental or car sharing. The second vehicle refers to a vehicle under the long-term use agreement. The “long-term use agreement” refers to, for example, an annual usage agreement, and refers to a vehicle lease or subscription agreement. Examples of the first vehicle and the second vehicle include an automobile (passenger car or truck). The second vehicle may be any vehicle that is physically different from the first vehicle. Therefore, the second vehicle may be a vehicle whose model is different from that of the first vehicle, or a vehicle whose model is identical to that of the first vehicle.

When determination is made from the second information that a family of the user is the person involved in the long-term use agreement on the second vehicle, the control unit of the information processing device may output the discounted fee obtained by reducing the fee for the short-term use of the first vehicle. Therefore, the fee for the short-term use of the first vehicle is reduced not only when the user is the person involved in the agreement but also when the family of the user is the person involved in the agreement. Thus, the range of the user convenience can be expanded.

The control unit of the information processing device may have the following configuration. That is, the control unit acquires information indicating a capacity of the second vehicle from the second information when the user or the family of the user is the person involved in the long-term use agreement on the second vehicle and information indicating the number of participants in a travel in which the user participates is acquired. The control unit outputs information for recommending the short-term use of the first vehicle and information indicating the discounted fee for the short-term use of the first vehicle when determination is made that the number of participants is larger than the capacity of the second vehicle.

The fact that the number of participants in the travel is larger than the capacity of the second vehicle means that not all the participants can get in the second vehicle and cannot go traveling to the destination in the second vehicle alone. By recommending the short-term use (rental) of the first vehicle at the discounted fee, the convenience of the user can be improved. In addition, the provider of the first vehicle can increase the opportunity for the use of the first vehicle. The short-term use of the first vehicle may be recommended when the number of participants in the travel is equal to or larger than the capacity of the second vehicle. That is, even if the number of participants in the travel is equal to the capacity, the use of the first vehicle may be recommended so that the participants can go traveling with a margin of occupant capacity by getting into the second vehicle and the first vehicle separately.

Examples of the first vehicle recommended for use include a vehicle having a capacity equal to or larger than a difference between the number of participants in the travel and the capacity of the second vehicle. For example, when the number of participants is seven and the capacity of the second vehicle is five, it is recommended to use the first vehicle that can accommodate two or more persons. Alternatively, the first vehicle recommended for use may be a vehicle having a capacity equal to or larger than the number of participants in the travel. In this case, it can be recommended that all the participants get into the first vehicle to go traveling without using the second vehicle for the travel. In this case, it is possible to improve the convenience of the user in that the vehicle cost is kept for only one vehicle.

When the user or the family of the user is the person involved in the long-term use agreement on the second vehicle and information indicating presumption of a change in a family structure of the user is acquired from the second information, the control unit may output information for recommending a vehicle according to a presumptive family structure, in which the change in the family structure of the user is deemed to be realized, as the first vehicle. Therefore, the user can rent the vehicle suitable for the change in the family structure as a vehicle to be used under the next long-term use agreement. The convenience is improved because the user can have an opportunity to change the vehicle under the long-term use agreement due to the change in the family structure. At this time, the convenience is also improved by the use of the first vehicle at the discounted fee.

The control unit may acquire the information indicating the presumption of the change in the family structure of the user from the second information when the user or the family of the user is the person involved in the long-term use agreement on the second vehicle. In this case, the control unit may output information for recommending the vehicle according to a presumptive family structure, in which the change in the family structure of the user is deemed to be realized, as the vehicle under the next long-term use agreement, and information indicating a reduction in a fee related to the next long-term use agreement. Therefore, the user can be given an opportunity to consider the vehicle under the next long-term use agreement, and the reduction in the fee can motivate the user toward the next long-term use agreement.

The information indicating the presumption of the change in the family structure may include at least one of information indicating pregnancy or childbirth of the user or a spouse of the user, information indicating a share of household with a relative of the user or a spouse of the user or a person other than the relative, and information indicating separation of a relative (for example, a child or a parent) who lived with the user. The information indicating the presumption of the change in the family structure is not limited to the above examples.

Hereinafter, an information processing device, an information processing method, and a program according to an embodiment will be described with reference to the drawings. The configuration of the embodiment is illustrative, and the present disclosure is not limited to the configuration of the embodiment.

### Configuration of Information Processing System

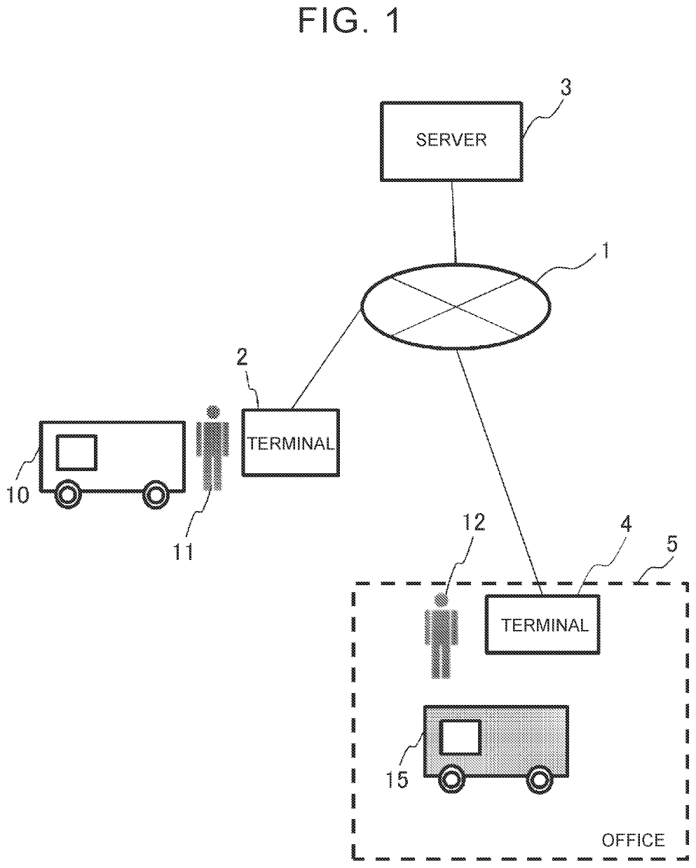

FIG. 1 is a schematic diagram of the information processing system according to the embodiment. In FIG. 1, the information processing system includes a network 1 and a terminal 2, a server 3, and a terminal 4 connected to the network 1.

The network 1 is a public communication network such as the Internet, and provides communication lines to the terminal 2, the server 3, the terminal 4, and the like. A wireless communication network may be connected to the network 1. The wireless communication network conforms to or complies with wireless communication standards available to the terminal 2. Examples of the wireless communication standards include 4th-Generation (4G) (Long Term Evolution (LTE)), 5th-Generation (5G), a wireless local area network (LAN, including Wi-Fi), and Bluetooth Low Energy (BLE), but the wireless communication standards may be any other standards.

The server 3 is used by a business operator that provides a vehicle subscription or lease service (referred to as “long-term vehicle use service”). That is, the server 3 is used to supply information via a website to a member (user) who has registered as a user for the long-term vehicle use service. The server is an example of an “information processing device”, and a vehicle subscription or lease agreement is an example of a “long-term use agreement on vehicle”.

In the present embodiment, the information for the members is provided to the user via the website, but may be provided from the server 3 via an application installed on the terminal 2 or the terminal 4.

The terminal 2 is used by a user 11 who is one of the members to access the server 3 (website). The user 11 is a person who has concluded a long-term use agreement with the business operator for a vehicle 10 that is a target vehicle of the long-term vehicle use service. The terminal 2 is used by the user 11 to view information provided by the server 3 and to input necessary information. The terminal 2 may be a fixed terminal or a mobile terminal. The user 11 can receive various services provided by the business operator via the server 3. For example, the user 11 can use a rental car by making a reservation for the rental car via the website of the server 3. The rental car is an example of a “first vehicle” that is used for a short period, and the vehicle 10 is an example of a “second vehicle” that is a target vehicle of the long-term use agreement.

Services to be provided by the business operator may include not only the long-term vehicle use service, but also a rental car service (short-term use agreement on a vehicle), a reservation for maintenance of the vehicle 10 in the long-term vehicle use service, and various travel-related reservations.

The travel refers to, for example, leaving a residence toward another place for sightseeing, recreation, or research, but for any other purposes. For example, the travel may be just a visit to another place. The travel may be an overnight trip or a day trip. The various travel-related reservations include reservations for services related to activities to be performed by the user 11 (events in which the user 11 participates) at places visited by the user 11, such as an accommodation facility, a restaurant, a recreation facility, and an activity facility. The reservations may include a reservation for rental of a vehicle (rental car), a ticket for an aircraft, or a tool to be used at a visited place.

The terminal 4 is placed at an office 5 of the business operator, and may be a fixed terminal or a mobile terminal. The terminal 4 is operated by an employee 12 in the office 5. The user 11 may visit the office 5, and the employee 12 may access the server 3 and refer to information provided to the terminal 4 to obtain necessary information, and may input information to the terminal 4 and register the information in the server 3. When the user 11 makes a reservation for rental of a vehicle 15 that is a rental car, the user 11 can rent the vehicle 15 at the office 5.

### Configuration of Terminal Device

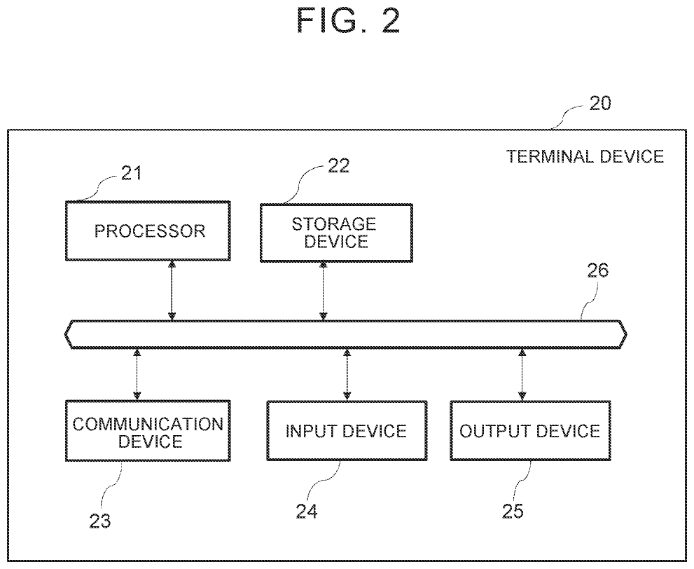

FIG. 2 is a diagram showing a configuration example of a terminal device 20 that can operate as the terminal 2, the server 3, or the terminal 4. The terminal device 20 can be configured by using, for example, a general-purpose information processing device (computer) such as a personal computer (PC) or a workstation, or a dedicated information processing device such as a server machine. The terminal device 20 to be used as the terminal 2 or the terminal 4 may be a smart device such as a smartphone or a tablet terminal. The terminal device 20 has a communication function and can be connected to the network 1 by wire or wireless.

In FIG. 2, the terminal device 20 includes a processor 21 as a processing unit or a control unit (controller), a storage device 22, a communication device 23, an input device 24, and an output device 25, which are connected to each other via a bus 26. The server 3 may be one terminal device 20 or a set (cloud) of two or more terminal devices 20.

The storage device 22 includes a main storage device and an auxiliary storage device. The main storage device is used as a storage area for programs and data, a loading area for programs, a work area for programs, and a buffer area for communication data. The main storage device is a random-access memory (RAM) or a combination of a

RAM and a read-only memory (ROM). The auxiliary storage device is used as a storage area for data and programs. The auxiliary storage device may be a non-volatile storage medium such as a hard disk drive, a solid state drive (SSD), a flash memory, or an electrically erasable programmable read-only memory (EEPROM).

The communication device 23 is a circuit that performs communication processing, and operates as a transmission unit and a reception unit (communication unit). Examples of the communication device 23 include a network interface card (NIC). The communication device 23 may be a wireless communication circuit that performs wireless communication (LTE, 5G, wireless LAN (Wi-Fi), BLE, and the like). The communication device 23 may include both the wireless communication circuit and a circuit that performs wired communication processing.

The input device 24 includes keys, buttons, a pointing device, a touch panel, and the like, and is used for inputting information. The input device 24 may include a microphone (audio input device). The output device 25 is, for example, a liquid crystal display or an organic electroluminescence (EL) display, and displays information and data. The output device 25 may include a loudspeaker (audio output device).

The processor 21 is, for example, a central processing unit (CPU). The processor 21 performs various processes by executing various programs stored in the storage device 22.

For example, the processor 21 of the terminal device 20 that operates as the terminal 2 accesses the server 3 and acquires information related to various services that can be provided by the business operator. The processor 21 of the terminal device 20 that operates as the server 3 performs a process of supplying information to the terminal 2 or the terminal 4 in response to a request from the terminal 2 (user 11) or the terminal 4.

A plurality of CPUs or a multi-core CPU may be applied as the processor 21. At least a part of the processes performed by the CPU may be performed by a processor other than the CPU such as a digital signal processor (DSP) or a graphical processing unit (GPU). At least a part of the processes performed by the CPU may be performed by a dedicated or general-purpose integrated circuit (hardware). Examples of the integrated circuit include an application-specific integrated circuit (ASIC) and a field-programmable gate array (FPGA). Alternatively, at least a part of the processes performed by the CPU may be executed by a combination of the processor and the integrated circuit. The combination is called, for example, a microcontroller (MCU), a system-on-a-chip (SoC), a system large-scale integration (LSI), or a chipset.

### Management Table

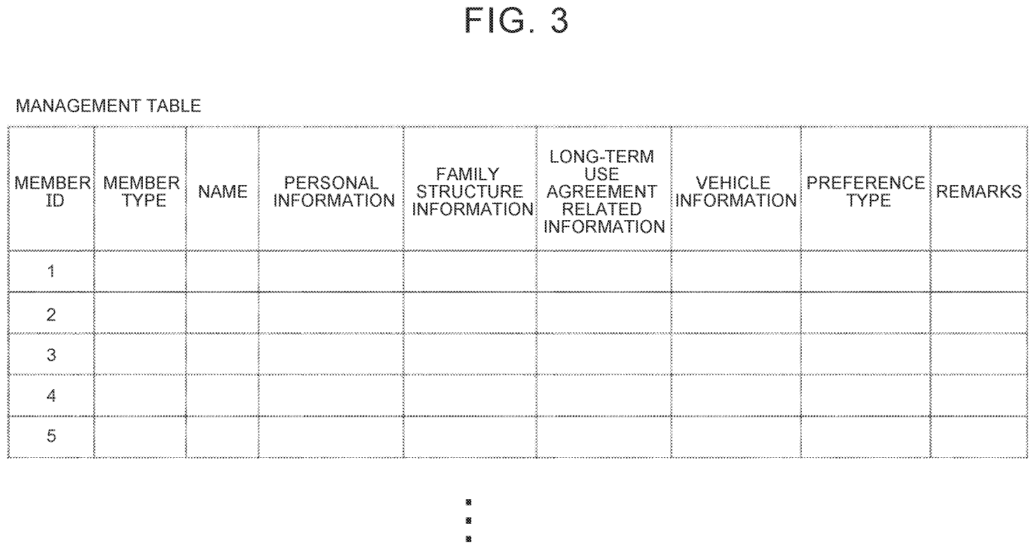

FIG. 3 is a diagram showing an example of a data structure of a management table managed by the terminal device 20 operating as the server 3. The management table is stored in, for example, the storage device 22 of the terminal device 20. The management table may be managed on a storage device other than the storage device 22 or on the network 1 and acquired from the network 1 or the like by the server 3 as needed.

The management table is a set of records of individual members (users). Each record includes a member type, a name, personal information, family structure information, long-term use agreement related information, vehicle information, a preference type, and remarks information associated with a member ID that is a member's identifier. The elements of the record are not limited to these contents.

The member type indicates whether the user is a regular member or a family member. The family member is a member of a regular member's family (spouse, child, or the like) and can receive a limited range of services as compared with the services that can be received by the regular member. The inclusion of the family member in the members is optional. The personal information includes information indicating, for example, age, gender, address, and contact information (telephone number or e-mail address) other than the member's name. The family structure information includes information indicating a family (that is, relatives (including a spouse, a child, and parents) living with the member), the number of cohabitants, names and ages of the cohabitants, and whether the cohabitants are members. The family structure information may include the type and the number of pets living together. When a family member is a member, the family structure information includes information indicating a member ID of this family member.

The long-term use agreement related information includes information indicating whether the member has a long-term use agreement on a vehicle. It is not a condition for membership registration that the user concludes a long-term use agreement. The member may be any person who has gone through a membership registration procedure before concluding the long-term use agreement. When the member is a person involved in the long-term use agreement, the long-term use agreement related information includes an identifier of a vehicle (vehicle 10 or the like) (vehicle ID) under the agreement, an agreement period, information indicating details of the agreement, and information indicating a usage fee of the vehicle.

The vehicle information includes, for example, a vehicle ID and specification information including the capacity of the vehicle. The preference type is information indicating the type of preference of the member with reference to, for example, the type of a target vehicle of the long-term use agreement selected by the member. The preference type information serves as reference information when selecting a vehicle under a long-term use agreement subsequent to the current agreement. There is no limitation on the contents of the remarks information, but information writable by the employee 12 or the like is stored in this field. For example, during maintenance of the vehicle 10, the employee 12 may hear from the user 11 about a change in the family structure, such as spouse's pregnancy or childbirth, separation of a cohabitant typified by independence of a child, or a share of household with the user's or spouse's parent. Information indicating the change in the family structure (information indicating the number of family members after the increase or decrease) is stored in this field.

### Vehicle Database (Vehicle DB)

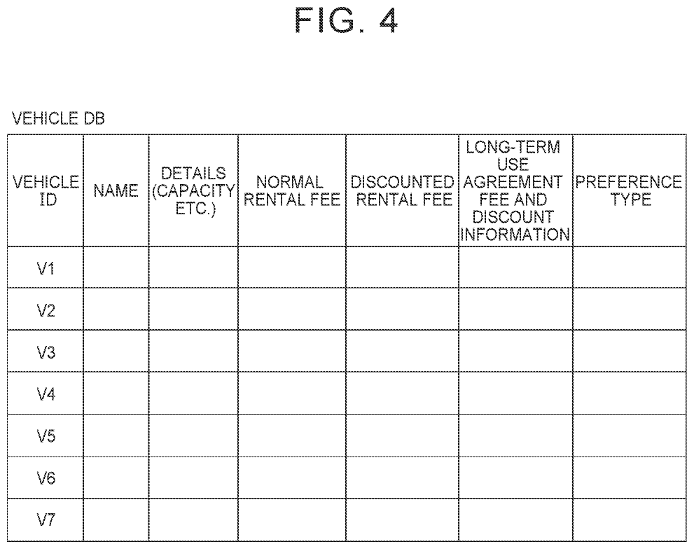

FIG. 4 is a diagram showing an example of a data structure of a vehicle DB. The vehicle DB is stored in, for example, the storage device 22 of the terminal device 20. The vehicle DB may be managed on a storage device other than the storage device 22 or on the network 1 and acquired from the network 1 or the like by the server 3 as needed.

The vehicle DB has a table format including a set of records for individual vehicle IDs. Each record includes, for example, a vehicle name, detailed information, a rental fee, a discounted rental fee, a long-term use agreement fee and discount information, and a preference type associated with the vehicle ID. The information elements in the record are not limited to these elements.

The detailed information includes specification information including the capacity of the vehicle and the like. The rental fee indicates a usage fee when the vehicle is rented as a vehicle based on a short-term use agreement (rental car). The discounted rental fee indicates a discounted fee to be applied when the vehicle is rented to a person involved in a long-term use agreement. Instead of the discounted rental fee, information indicating a discount rate for the rental fee may be stored.

The long-term use agreement fee is a usage fee (normal fee) to be applied when the vehicle identified by the vehicle ID is set as a target vehicle under a next long-term use agreement. The discount information indicates a discount rate or a discount amount for the long-term use agreement fee, or a fee after discount from the normal fee. The next long-term use agreement may be made after expiration of the period of the current long-term use agreement or transferred before the expiration of the period. The discount amount may be the same regardless of whether the period has expired, or may be different depending on whether the period has expired. The preference type is the same as that described for the management table. When the record of the management table is registered, a record of the vehicle DB whose vehicle ID matches the vehicle ID in the record of the management table is read from the vehicle DB and registered as the vehicle information. The preference type is registered in the “preference type” field in the record of the management table.

### Operation Example

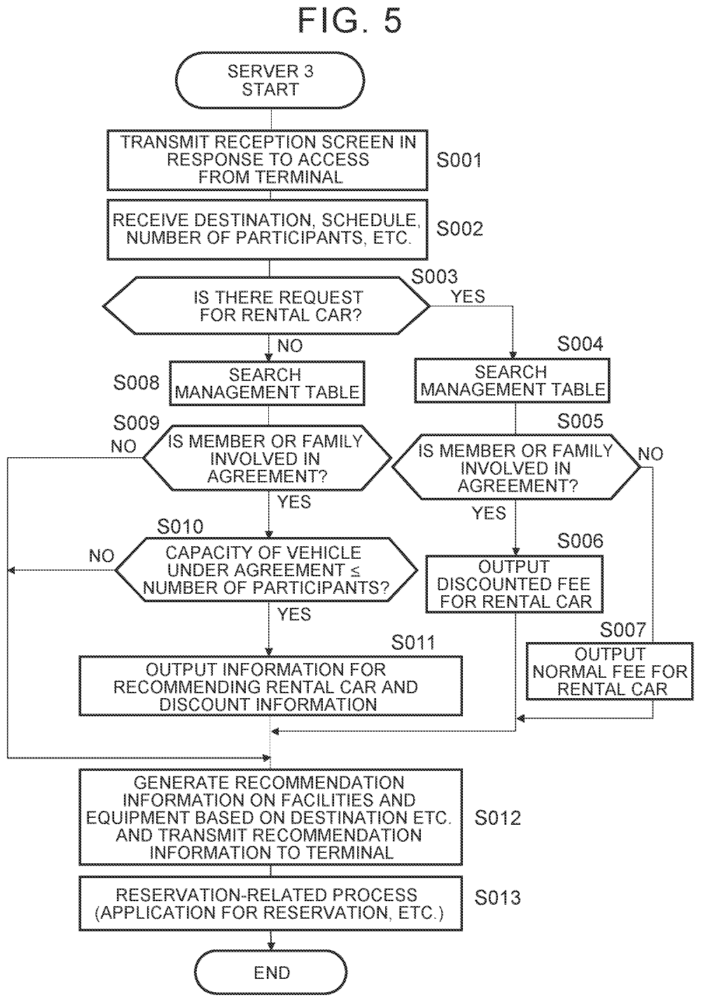

FIG. 5 is a flowchart showing an example of a process in the processor 21 of the terminal device 20 that operates as the server 3 (processor 21 of the server 3). The process shown in FIG. 5 is performed by the processor 21 of the server 3 executing a program.

When making a reservation for a travel, a member such as the user 11 of the vehicle 10 uses the terminal 2 or the terminal 4 to access the website provided by the server 3 via the network 1. In the present embodiment, description will be given of an exemplary case where the user 11 who is a person involved in a long-term use agreement on the vehicle 10 operates the terminal 2 to access the website of the server 3.

In Step S001, the processor 21 of the server 3 accepts the access from the terminal 2 and transmits, to the terminal 2 (user 11), data on a reception screen for information related to the travel. On the reception screen, the user inputs a destination of the travel, a schedule, the number of participants, a desired activity at the destination, and a facility (accommodation facility, restaurant, recreation facility, activity facility, or the like) or equipment (rental car or the like) for which a reservation is desired.

In Step S002, the processor 21 of the server 3 receives, via the network 1, the information and a member ID input to the terminal 2 by the user 11 on the reception screen (referred to as “input information”). In Step S003, the processor 21 determines whether the input information includes information indicating the user's request for a rental car. When determination is made that the information indicating the request for rental is included, the process proceeds to Step S004. Otherwise, the process proceeds to Step S008.

In Step S004, the processor 21 searches the management table (FIG. 3) for a corresponding record by using the member ID in the input information, and reads a hit record.

In Step S005, the processor 21 determines whether the member or the member's family is a person involved in the long-term use agreement. That is, the processor 21 refers to long-term use agreement related information in the record read in Step S004, and determines whether there is a long-term use agreement. When determination is made that there is a long-term use agreement, determination is made that the member is the person involved in the long-term use agreement. When determination is made that there is no long-term use agreement of the member in the long-term use agreement related information, the processor 21 acquires a member ID of the family member from family structure information in the record, and refers to the management table to extract a record corresponding to the member ID. The processor 21 determines whether information indicating that there is a long-term use agreement of the family is included in long-term use agreement related information in the extracted record. When determination is made that the information indicating that there is a long-term use agreement of the family is included, determination is made that the member's family is the person involved in the long-term use agreement. When determination is made that the member or his/her family is the person involved in the agreement, the process proceeds to Step S006. Otherwise, the process proceeds to Step S007.

In Step S006, the processor 21 reads, from the vehicle DB, a record of a vehicle that meets a request about a model or a capacity of the vehicle in the information indicating the request for the rental car. At this time, preference type information in the record of the management table may be used for narrowing down the vehicle. The processor 21 outputs (calculates) a rental fee discounted from the normal fee by using a discounted rental fee in the record read from the vehicle DB. Then, the process proceeds to Step S012.

In Step S007, the processor 21 reads, from the vehicle DB, a record of a vehicle that meets a request about a model or a capacity of the vehicle in the information indicating the request for the rental car. The processor 21 acquires a normal rental fee in the record read from the vehicle DB, and outputs (calculates) the fee as the rental fee. Then, the process proceeds to Step S012.

When the process proceeds to Step S008, the processor 21 executes, in Steps S008 and S009, the same processes as those in Steps S004 and S005. When determination is made in Step S009 that the member or his/her family is the person involved in the agreement, the process proceeds to Step S010. Otherwise, the process proceeds to Step S012.

In Step S010, determination is made, by referring to the vehicle information in the record read in Step S008, whether the capacity of the vehicle under the long-term use agreement is equal to or smaller than the number of participants in the travel in the input information. The determination may be made as to whether the capacity is smaller than (falls below) the number of participants. When determination is made that the capacity is equal to or smaller than the number of participants, the process proceeds to Step S011. Otherwise, the process proceeds to Step S012.

In Step S011, the processor 21 generates information for recommending a rental car different from the vehicle under the agreement, and outputs (calculates) a discounted fee for the rental car. That is, the processor 21 determines a difference between the capacity of the vehicle under the agreement and the number of participants, and extracts, from the vehicle DB, a record of a vehicle having a capacity equal to or larger than the difference as a record of a vehicle that is a candidate for the rental car. Alternatively, a record of a vehicle having a capacity equal to or larger than the total number of participants may be extracted as a candidate record for the rental car. At this time, the vehicle to be recommended as the rental car may be narrowed down by using the preference type information in the record of the management table. The processor 21 can extract records of two or more vehicles satisfying the capacity condition from the vehicle DB. The processor 21 calculates the discounted fee for the rental car by applying a discounted rental fee in the record of each vehicle serving as the rental car candidate read from the vehicle DB to a usage fee of the rental car candidate.

In Step S012, the processor 21 generates recommendation information on facilities and equipment based on the destination of the travel, and transmits the recommendation information to the terminal 2 or the terminal 4. That is, the processor 21 generates recommendation information indicating, for example, a name, place, and usage fee of a facility or equipment based on an activity (accommodation, eating and drinking, or participation in recreation or activity) requested by the user in the input information. This recommendation information may include information on a rental car requested by the user and its fee that are obtained in Step S007. The recommendation information may also include a rental car requested by the user and its discounted rental fee that are obtained in Step S006. The recommendation information may also include information for recommending the use of the rental car candidate obtained in Step S011, and information indicating the discounted rental fee.

The user 11 refers to the recommendation information output to (displayed on) the output device 25 of the terminal 2 or the terminal 4, and inputs, to the terminal 2 or the terminal 4, reservation application information on the facility or equipment for which the user 11 wants to make a reservation, thereby transmitting the information to server 3.

In Step S013, the processor 21 performs a reservation-related process. That is, the processor 21 receives the reservation application information transmitted from the terminal 2 or the terminal 4, and exchanges procedures to make a reservation with the user (terminal 2 or terminal 4). In this way, a reservation is made for the facility and equipment (rental car or the like) that the user wants to use. When the member or his/her family is a person involved in the long-term use agreement, the rental car can be used at a discounted fee. When the member or his/her family is a person involved in the agreement and the number of participants in the travel is equal to or larger than the capacity of the vehicle under the agreement, it is recommended to use the rental car at a discounted fee. One, two, or more rental car candidates to be recommended can be shown to the user. At this time, the processor 21 may recommend the use of a rental car in combination with the vehicle under the agreement, may recommend the use of a rental car that accommodates all the participants (travel in one vehicle), or may recommend both options.

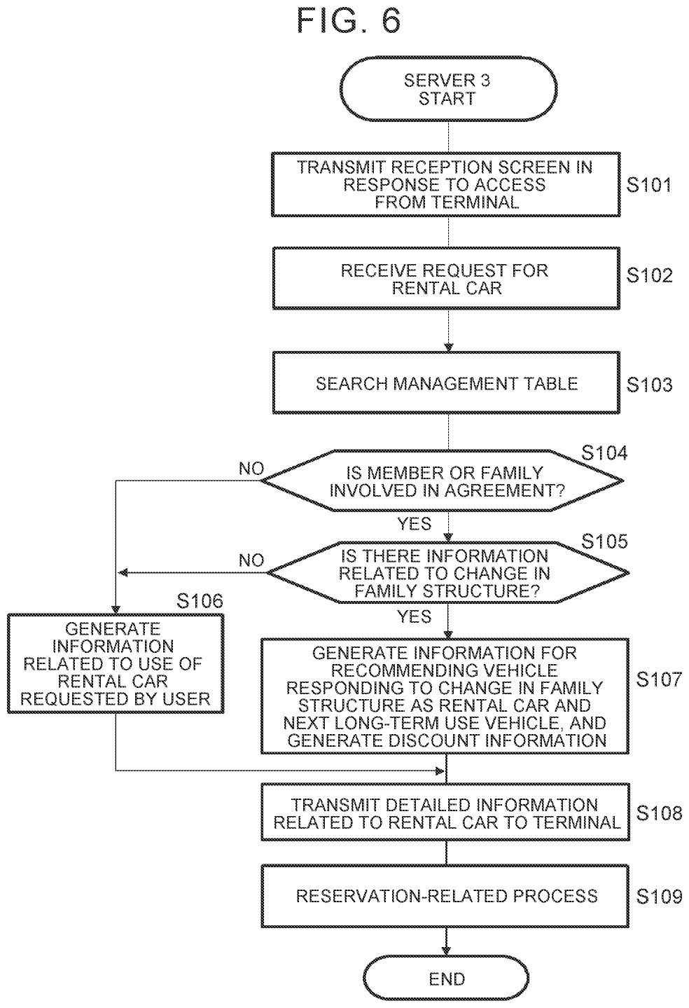

FIG. 6 is a flowchart showing an example of a process in the server 3. Description will be given of an operation example in which the user 11 who is a person involved in the long-term use agreement on the vehicle 10 accesses the website of the server 3 by using the terminal 2 and applies for the use of a rental car.

In Step S101, the processor 21 of the server 3 transmits data on a reception screen in response to the access from the terminal 2. In Step S102, the user 11 inputs information indicating a request for a rental car by using the input device 24 and the reception screen displayed on the output device 25 of the terminal 2. The input information is transmitted to the server 3.

In Step S103, the processor 21 of the server 3 that has acquired the input information searches the management table (FIG. 3) for a corresponding record by using a member ID in the input information, and reads the record.

In Step S104, the processor 21 determines whether the member or the member's family is a person involved in the long-term use agreement. Since this process is the same as that in Step S005, description will be omitted. When determination is made that the member or his/her family is the person involved in the agreement, the process proceeds to Step S105. Otherwise, the process proceeds to Step S106.

In Step S105, the processor 21 refers to remarks information in the member's record and determines whether the remarks information includes information indicating a change in the family structure (information indicating an increase or decrease in the number of family members). When determination is made that there is information indicating a change in the family structure, the process proceeds to Step S107. Otherwise, the process proceeds to Step S106.

In Step S106, the processor 21 generates information related to the rental of the car requested by the user 11 (fee and the like) based on information obtained from the vehicle DB by using a vehicle ID in the input information.

In Step S107, when the information indicating the change in the family structure indicates an increase in the number of family members, the processor 21 extracts, from the vehicle DB, a vehicle different from the vehicle 10 related to the long-term use agreement (vehicle under agreement), such as a vehicle having a large capacity. Then, the processor 21 generates information for recommending the extracted vehicle as a vehicle under the next long-term use agreement and information indicating that the fee for the long-term use will be discounted when the long-term use agreement is concluded for the vehicle. When the number of family members has decreased due to the change in the family structure, a vehicle having a smaller capacity may be recommended.

In Step S108, the processor 21 transmits, to the terminal 2, detailed information related to the rental car, including the information generated in Step S106 or Step S107. The user 11 of the terminal 2 refers to the detailed information related to the rental car, determines whether to make a reservation for the rental car, and applies for the reservation as necessary.

At this time, a vehicle (for example, the vehicle 15) responding to the change in the family structure is proposed as the recommended vehicle for rental, and a discounted fee lower than the normal fee is presented as the rental fee for the vehicle. This vehicle is recommended as a candidate for the vehicle under the next long-term use agreement. In addition, information is provided about a discounted fee when this vehicle is selected as the vehicle under the next agreement.

The processes of Step S105 and Step S107 shown in FIG. 6 may be inserted between Step S010 and Step S011 shown in FIG. 5. Then, information on a vehicle satisfying the capacity condition and responding to the change in the family structure may be output as information on a rental car candidate and a vehicle under the next long-term use agreement together with discounted fees. When the information indicating the change in the family structure is not acquired, a vehicle satisfying the capacity condition is shown as a rental car candidate. The processes of Step S105, Step S106, and Step S107 shown in FIG. 6 may be inserted between Step S005 and Step S006 shown in FIG. 5. When information indicating presumption of the change in the family structure is acquired, information on a vehicle and a discounted fee according to a presumptive family structure, in which the change in the family structure of the user is deemed to be realized, may be output together with or in place of the information on the vehicle requested by the user 11.

### Actions and Effects of Embodiment

In the server 3 (information processing device) according to the embodiment, the processor 21 (control unit) receives (acquires), from the terminal 2 (user 11), the input information (first information) including a request for a rental car (first vehicle). The processor 21 can acquire the record associated with the user 11 registered (stored) in the management table (second information related to the person involved in the long-term use agreement on the second vehicle). Then, the processor 21 can determine that the user 11 is the person involved in the long-term use agreement on the vehicle 10 (second vehicle) from the input information and the record of the management table. In this case, the processor 21 can output (calculate) a discounted fee by reducing the normal fee of the rental car. The user 11 who is the person involved in the long-term use agreement (lease or subscription agreement) on the vehicle 10 is given an incentive that the rental car can be used at the discounted fee. Therefore, the convenience of the user 11 who is the person involved in the agreement is improved.

In the embodiment, the rental car can be used at the discounted fee not only when the user 11 is the person involved in the agreement but also when the family of the user 11 is the person involved in the agreement. In this respect as well, the convenience of the user 11 is improved.

The server 3 (processor 21) can acquire, from the user 11, the information indicating the number of participants in the travel in which the user 11 participates when the user 11 or his/her family is the person involved in the agreement. In this case, the server 3 can acquire the information indicating the capacity of the vehicle 10 from the management table. When determination is made that the number of participants is larger than the capacity of the vehicle 10, the server 3 can output the information for recommending the use of the rental car and the information indicating the discounted fee of the rental car, and transmit these pieces of information to the terminal 2. Therefore, when the user 11 cannot go traveling in the vehicle 10 alone and the use of a rental car is taken into consideration, the user 11 is provided with the information indicating that the rental car can be used at the discounted fee. This makes it possible to improve the convenience of the user 11.

As the rental car candidate information, the user 11 can receive the candidate information for a travel with two vehicles including the vehicle 10 and the rental car, and the candidate information for a travel with one rental car. As a result, the user 11 can consider the use of the rental car with many options.

In the embodiment, when the user 11 or his/her family is the person involved in the agreement, the server 3 can acquire the information indicating the presumption of the change in the family structure of the user 11 from the remarks information (second information) of the management table. In this case, the server 3 can output the information for recommending a vehicle according to the presumptive family structure, in which the change in the family structure of the user is deemed to be realized, as a rental car. As a result, the user 11 can consider the vehicle under the long-term use agreement through the use of the rental car, thereby improving the convenience of the user 11.

Based on the information indicating the presumption of the change in the family structure of the user 11, the server 3 can output the information for recommending a vehicle according to the presumptive family structure, in which the change in the family structure of the user is deemed to be realized, as the vehicle under the next long-term use agreement, and the information indicating a reduction in the fee. This makes it possible to provide the user 11 with an opportunity to use, at a low cost, the vehicle that the user 11 may use in the future.

### Others

The embodiment described above is merely exemplary, and the present disclosure may be modified as appropriate without departing from the spirit and scope of the present disclosure. The process described as being executed by a single device may be executed by a plurality of devices in cooperation. Alternatively, the process described as being executed by different devices may be executed by a single device. In a computer system, the hardware configuration (server configuration) that implements functions can be changed flexibly.

Aspects of the present disclosure may include an information processing system including the information processing device described above in addition to the information processing device, the information processing method, and the non-transitory computer-readable medium described above.

The present disclosure may be embodied such that a computer program that implements the functions described in the embodiment described above is supplied to a computer and is read and executed by one or more processors of the computer. The computer program may be provided to the computer by being stored in a non-transitory computer-readable storage medium connectable to a system bus of the computer, or may be provided to the computer via a network. Examples of the non-transitory computer-readable storage medium include any types of disk or disc such as magnetic disks (for example, a floppy (registered trademark) disk and a hard disk drive (HDD)) and optical discs (for example, a compact disc read-only memory (CD-ROM), a digital versatile disc (DVD), and a Blu-ray disc). Examples of the non-transitory computer-readable medium also include any types of medium suitable to store electronic instructions, such as a read-only memory (ROM), a random-access memory (RAM), an erasable programmable ROM (EPROM), an EEPROM, a magnetic card, a flash memory, and an optical card.

What is claimed is:

1. An information processing device comprising a processor configured to:
when first information is acquired from a user, acquire second information, the first information indicating a request for a first use of a first vehicle for a first period, the second information being related to a user involved in an agreement on a second vehicle different from the first vehicle, the user involved in the agreement having concluded an agreement on a second use of the second vehicle for a second period, the second period being longer than the first period;
determine whether the user is the user involved in the agreement on the second vehicle based on the first information and the second information; and
output a discounted fee obtained by reducing a fee for the first use when determination is made that the user is the user involved in the agreement on the second vehicle.

2. The information processing device according to claim 1, wherein the processor is configured to:
determine whether a family of the user is the user involved in the agreement on the second vehicle based on the second information; and
output the discounted fee when determination is made that the family of the user is the user involved in the agreement on the second vehicle.

3. The information processing device according to claim 1, wherein the processor is configured to:
acquire information indicating a capacity of the second vehicle from the second information when determination is made that the user or a family of the user is the user involved in the agreement on the second vehicle and information indicating the number of participants in a travel in which the user participates is acquired;
determine whether the number of the participants is larger than the capacity of the second vehicle; and
output information for recommending the first use and information indicating the discounted fee when determination is made that the number of the participants is larger than the capacity of the second vehicle.

4. The information processing device according to claim 3, wherein the processor is configured to recommend the first use while presenting, as the first vehicle, a vehicle having a capacity equal to or larger than a difference between the number of the participants and the capacity of the second vehicle.

5. The information processing device according to claim 3, wherein the processor is configured to output the information for recommending the first use while presenting, as the first vehicle, a vehicle having a capacity equal to or larger than the number of the participants.

6. The information processing device according to claim 1, wherein the processor is configured to, when determination is made that the user or a family of the user is the user involved in the agreement on the second vehicle and information indicating presumption of a change in a family structure of the user is acquired from the second information, output information for recommending the first use while presenting, as the first vehicle, a vehicle according to a presumptive family structure of the user,
wherein the change in the family structure of the user is deemed to be realized in the presumptive family structure.

7. The information processing device according to claim 1, wherein the processor is configured to, when determination is made that the user or a family of the user is the user involved in the agreement on the second vehicle and information indicating presumption of a change in a family structure of the user is acquired from the second information, output information for recommending a vehicle according to a presumptive family structure of the user as a target vehicle in a use for a period longer than the first period, and information indicating a reduction in a fee related to the use for the period longer than the first period,
wherein the change in the family structure of the user is deemed to be realized in the presumptive family structure.

8. The information processing device according to claim 6, wherein the information indicating the presumption of the change in the family structure includes information indicating pregnancy or childbirth of the user or a spouse of the user.

9. The information processing device according to claim 6, wherein the information indicating the presumption of the change in the family structure includes information indicating that a relative of the user or a spouse of the user or a person other than the relative lives with the user or the spouse of the user.

10. The information processing device according to claim 6, wherein the information indicating the presumption of the change in the family structure includes information indicating that a person who lived with the user lives separately from the user.

11. An information processing method comprising:
when a processor has acquired first information from a user, acquiring second information by the processor, the first information indicating a request for a first use of a first vehicle for a first period, the second information being related to a user involved in an agreement on a second vehicle different from the first vehicle, the user involved in the agreement having concluded an agreement on a second use of the second vehicle for a second period, the second period being longer than the first period;
determining, by the processor, whether the user is the user involved in the agreement on the second vehicle based on the first information and the second information; and
outputting, by the processor, a discounted fee obtained by reducing a fee for the first use when determination is made that the user is the user involved in the agreement on the second vehicle.

12. The information processing method according to claim 11, further comprising:
determining, by the processor, whether a family of the user is the user involved in the agreement on the second vehicle based on the second information; and
outputting, by the processor, the discounted fee when determination is made that the family of the user is the user involved in the agreement on the second vehicle.

13. The information processing method according to claim 11, further comprising:
acquiring, by the processor, information indicating a capacity of the second vehicle from the second information when determination is made that the user or a family of the user is the user involved in the agreement on the second vehicle and the processor has acquired information indicating the number of participants in a travel in which the user participates;
determining, by the processor, whether the number of the participants is larger than the capacity of the second vehicle; and
outputting, by the processor, information for recommending the first use and information indicating the discounted fee when determination is made that the number of the participants is larger than the capacity of the second vehicle.

14. The information processing method according to claim 11, further comprising, when determination is made that the user or a family of the user is the user involved in the agreement on the second vehicle and the processor has acquired information indicating presumption of a change in a family structure of the user from the second information, outputting, by the processor, information for recommending the first use while presenting a vehicle according to a presumptive family structure of the user as the first vehicle,
wherein the change in the family structure of the user is deemed to be realized in the presumptive family structure.

15. The information processing method according to claim 11, further comprising, when determination is made that the user or a family of the user is the user involved in the agreement on the second vehicle and the processor has acquired information indicating presumption of a change in a family structure of the user from the second information, outputting, by the processor, information for recommending a vehicle according to a presumptive family structure of the user as a target vehicle in a use for a period longer than the first period, and information indicating a reduction in a fee related to the use for the period longer than the first period,
wherein the change in the family structure of the user is deemed to be realized in the presumptive family structure.

16. A non-transitory computer-readable medium on which a program is recorded, the program causing, when executed by a processor, an information processing device to:
when first information is acquired from a user, acquire second information, the first information indicating a request for a first use of a first vehicle for a first period, the second information being related to a user involved in an agreement on a second vehicle different from the first vehicle, the user involved in the agreement having concluded an agreement on a second use of the second vehicle for a second period, the second period being longer than the first period;
determine whether the user is the user involved in the agreement on the second vehicle based on the first information and the second information; and
output a discounted fee obtained by reducing a fee for the first use when determination is made that the user is the user involved in the agreement on the second vehicle.

17. The non-transitory computer-readable medium according to claim 16, wherein the program causes, when executed by the processor, the information processing device to further perform:
determining whether a family of the user is the user involved in the agreement on the second vehicle based on the second information; and
outputting the discounted fee when determination is made that the family of the user is the user involved in the agreement on the second vehicle.

18. The non-transitory computer-readable medium according to claim 16, wherein the program further causes, when executed by the processor, the information processing device to:
acquire information indicating a capacity of the second vehicle from the second information when determination is made that the user or a family of the user is the user involved in the agreement on the second vehicle and information indicating the number of participants in a travel in which the user participates is acquired;
determine whether the number of the participants is larger than the capacity of the second vehicle; and
output information for recommending the first use and information indicating the discounted fee when determination is made that the number of the participants is larger than the capacity of the second vehicle.

19. The non-transitory computer-readable medium according to claim 16, wherein the program further causes, when executed by the processor, the information processing device to, when determination is made that the user or a family of the user is the user involved in the agreement on the second vehicle and information indicating presumption of a change in a family structure of the user is acquired from the second information, output information for recommending the first use while presenting a vehicle according to a presumptive family structure of the user as the first vehicle,
wherein the change in the family structure of the user is deemed to be realized in the presumptive family structure.

20. The non-transitory computer-readable medium according to claim 16, wherein the program further causes, when executed by the processor, the information processing device to, when determination is made that the user or a family of the user is the user involved in the agreement on the second vehicle and information indicating presumption of a change in a family structure of the user is acquired from the second information, output information for recommending a vehicle according to a presumptive family structure of the user as a target vehicle in a use for a period longer than the first period, and information indicating a reduction in a fee related to the use for the period longer than the first period,
wherein the change in the family structure of the user is deemed to be realized in the presumptive family structure.
